(19) United States
(12) Patent Application Publication
(10) Pub. No.: US 2010/0174587 A1
(43) Pub. Date: Jul. 8, 2010

(54) PET SERVICE EXCHANGE MARKET

(76) Inventors: Marco Seidman, Wayland, MA (US); Daniel Loredo, Miami, FL (US)

Correspondence Address: LANDO & ANASTASI, LLP, ONE MAIN STREET, SUITE 1100, CAMBRIDGE, MA, 02142, US

(21) Appl. No.: 12/349,621

(22) Filed: Jan. 7, 2009

(51) Int. Cl. G06Q 50/00; G06Q 30/00; G06Q 10/00

(52) U.S. Cl. 705/11; 705/400; 705/30; 705/34; 705/347

(57) ABSTRACT

Embodiments of the present invention are directed to methods and systems of creating and operating a pet service exchange marketplace. The marketplace facilitates the matching of members desiring pet care services with other members willing to provide these services. Point values may be established for various services and these points may be debited or credited to members of the pet care service marketplace in exchange for the performance of pet care services. According to some embodiments, the methods and systems operate to maintain an equilibrium between negative point balances and positive point balances of the members of the system.

### BACKGROUND OF INVENTION

1. Field of Invention

One or more embodiments of the present invention are directed toward the creation and operation of a pet care service exchange marketplace.

2. Discussion of Related Art

Barter is a type of trade in which goods or services are directly exchanged for other goods and/or services, without the use of money. It can be bilateral or multilateral, and may exist parallel to monetary systems.

In the past, goods were exchanged on a one-to-one basis with the intent that the value of the goods traded was of relatively equal value. Prior to the establishment of currencies, barter was the most accepted form of commerce. The equality of the value in a one-on-one barter is often an issue.

While one-to-one bartering is still practiced between individuals and businesses on an informal basis, barter exchanges have developed to facilitate third party bartering. A barter exchange operates as a broker and bank and each participating member has an account which is debited when purchases are made, and credited when sales are made.

A barter exchange is a commercial organization that provides a trading platform and bookkeeping system for its members or clients. The members of the barter exchange buy and sell products and services to each other using an internal currency known as barter or trade dollars.

Some barter exchanges facilitate the trade of members' time for performing services and the credits awarded are valued in terms of service hours.

### SUMMARY OF INVENTION

The present invention is directed to the establishment and the operation of a marketplace for the exchange of pet care services. Pet care services including services such as dog walking, cat sitting, fish feeding, bird boarding, or other services desired by members of the marketplace would be performed by members for other members. Upon completion of a pet care service, pet care service points would be transferred to the service provider from the service recipient. Various methods of pre-determining, dynamically assigning, and in some examples, adjusting a point value for a service are contemplated in different embodiments of the invention.

A marketplace for the exchange of pet care services in accordance with examples of the present invention provide a medium through which pet owners can obtain referrals and/or find pet care service providers that could provide services desired by the pet owner. Through the pet care service marketplace, a pet owner would be able to exchange pet care services with other members of the marketplace without the need for the exchange of cash. The pet care service marketplace would enable a first member pet owner to perform a pet care service for another member, and to receive pet care services from other members of a value commensurate with that of the service or services provided by the first member. For example, one member pet owner could trade dog walking services with another member such that each would walk the other's dog along with his own on alternate days or at different times each day.

A marketplace for the exchange of pet care services in accordance with embodiments of the present invention would provide a readily accessible list of pet care service providers whom a pet owner might obtain pet care services from. A member could use the pet care service marketplace to find service providers willing to provide services that might not be available from places such as conventional kennels. This would provide a benefit to pet owners by reducing the time they would need to spend searching for someone to perform pet care services for their pets. Also, in some embodiments, the pet care service marketplace would facilitate the selection of a trustworthy pet care service provider to provide services for a member's pet. Further, the pet care service marketplace would enable persons of limited financial means to obtain pet care services for their pet(s) at little or no financial cost by allowing them to perform services for other members in order to “pay” for the services which they receive.

The pet care service marketplace would in some examples facilitate the creation of a community of pet owners willing to assist other pet owners. The pet care service marketplace would in some examples facilitate the creation of a social network among pet owners and their pets which would facilitate the introduction of members and pets that might otherwise not have met and had the chance to interact.

According to at least one embodiment of the present invention there is provided a computer-implemented method of matching pet care service providers with pet owners. The method comprises acts of creating a member profile for at least one member in response to a request to join the pet care service marketplace, determining, by a processor, a pre-determined point value for a pet care service, assigning the pre-determined point value to the pet care service, matching, by a processor, a service desired by at least one member with a service willing to be performed by at least one other member, determining that the at least one member had accumulated at least the pre-determined point value, debiting a number of points of the at least one member after completion of the pet care service by the at least one other member, and crediting a number of points of the at least one other member after completion of the pet care service by the at least one other member.

In accordance with some aspects of the method, the at least one other member has a member profile which indicates at least one of a type of pet care service the at least one member is willing to perform and that the at least one other member is willing to provide. Creating a member profile in some aspects includes accepting information associated with the member through a user interface displayed on a computer. In some aspects, the member profile is stored in a database. In some aspects, the database is a computer database, and in some aspects is distributed over multiple computers.

In accordance with some aspects, a total number of points assigned to all members of the pet care service marketplace sums to zero. In some aspects, one or more members of the pet care service marketplace is permitted to have a negative number of points, and in some aspects, a member is allowed to have a negative point balance only on the condition that the member pays a deposit. In further aspects, a service charge is assessed against a member having a negative number of points for more than a predetermined period of time, such as after 30 days.

In accordance with some aspects of the method, assigning a point value to a pet care service comprises assigning, by a processor, a value at least in part based upon a baseline point value for a class of pet care services including the pet care service the at least one member is willing to perform.

In accordance with some aspects, matching the at least one member with at least one other member comprises matching the at least one member with all members matching a set of criteria provided by the at least one member. In some aspects, the set of criteria includes at least one of a physical location of a member willing to provide the pet care service desired by the at least one member, a reputation score of a member willing to provide the pet care service desired by the at least one member, an experience level of a member willing to provide the pet care service desired by the at least one member, and whether a background check has been performed on a member willing to provide the pet care service desired by the at least one member. Some aspects of the method further comprise providing a list of members willing to perform a service desired by a first member to the first member. In some aspects, an indication of the pre-determined point value is also provided. In some aspects, the list is provided in a web site. In some aspects, the web site includes information pertaining to the list of members, including at least one of a drop down menu including criteria which the first member may use to narrow the list of members and a map displaying the geographical location of at least a sub-set of the list of members. In some aspects, the pre-determined point value is re-calculated.

In accordance with some aspects, the method further comprises allowing the first member to choose a member to provide the desired service from the list provided, and in some aspects, the at least one member is permitted to select a member to provide the pet care service desired by the at least one member from the members matching the set of criteria provided by at least one member. Some aspects further comprise facilitating communications between the first member and the chosen member over a communications network and some aspects of the method further comprise providing a mechanism through which the first member may choose to accept or reject the service of the chosen member.

In accordance with some aspects, the method further comprises including in the member profile of the at least one member a type of service the at least one member desires to have performed, and assigning, by a processor, a point value to the service the at least one member desires to have performed. In some aspects, the act of assigning a point value to the service the at least one member desires to have performed comprises assigning a value based at least in part upon a baseline point value for a class of pet care services including the service the at least one member desires to have performed.

In accordance with some aspects, the method further comprises allowing the at least one member to rate the pet care service provided by the at least one other member, and making the rating of the at least one member available to at least one additional member. In some aspects, the rating of the at least one member affects a reputation score of the at least one other member.

In accordance with some aspects of the method, determining, by a processor, a pre-determined point value of a pet care service includes providing the processor with a point value assigned by the at least one member and in some aspects, the at least one other member may bid a point value other than the assigned point value.

In accordance with at least one other embodiment of the present invention, there is provided a method of operating a pet care service marketplace. The method comprises acts of receiving from a prospective member an application for membership in the pet care service marketplace, calculating, using a processor, a point value for at least one type of pet care service available through the marketplace, assigning the point value to the at least one type of pet care service available through the marketplace, making the prospective member a member of the pet care service marketplace, entering information associated with the member into a pet care service market database, the database residing on at least one computer, the information associated with the member including at least one of the at least one type of pet care service the member would be willing to provide and a type of pet care service the member desires, matching, using a processor, a pet care service desired by a first member with a pet care service which a second member in the pet care service market database is willing to perform, facilitating communication between the first member and the second member, wherein the communication includes an act of communication over a communications network, recording a completion of the pet care service by the second member in the pet care service market database, debiting a number of points of the first member responsive to the recording of the completion of the pet care service by the second member in the pet care service market database by the point value of the pet care service completed and crediting a number of points of the second member responsive to the recording of the completion of the pet care service by the second member in the pet care service market database by the point value of the pet care service completed.

In accordance with some aspects, the method further comprises requiring the prospective member to specify at least one type of pet care service the prospective member would be willing to provide and some aspects comprise assigning a point value to the at least one type of pet care service the prospective member would be willing to provide. In some aspects, the method further comprises an act of receiving from a prospective member a waiver of liability associated with a pet service.

In accordance with some aspects, the method further comprises an act of collecting a membership fee from members. In some aspects a service fee is collected for matching the first member with the second member, and in some aspects the service fee is related to the point value assigned to the pet care service to be performed.

In accordance with some aspects of the method, the information associated with the member further includes at least one characteristic of a pet owned by the member, the at least one characteristic including at least one of pet type, pet breed, pet gender, pet age, whether the pet is neutered, a description of the personality of the pet, a description of the friendliness of the pet toward other pets, a description of the friendliness of the pet toward people, pet energy level, pet size, and pet special needs and in some aspects, the information associated with the member further includes at least one evaluation of at least one other member of the at least one characteristic of the pet owned by the member.

In some aspects, the method further comprises an act of performing a background check on a prospective member, and in some aspects, a reputation score of the second member is influenced by at least one of whether a background check has been performed on the second member, and the feedback score of the second member.

In accordance with some aspects, the method further comprises an act of entering feedback provided by the first member regarding a service performed by the second member into the pet care service market database and in some aspects the method further comprises an act of calculating, using a processor, a feedback score based on the feedback provided by the first member and assigning the feedback score to the second member. In some aspects, criteria including the feedback score of the second member is used to adjust the point value assigned to the type of pet care service.

In accordance with some aspects of the method assigning a point value to a type of pet care service is performed by an operator of the pet care service marketplace and in some aspects, the point value assigned to the type of pet care service is determined utilizing criteria including at least the difficulty of providing the type of pet care service.

In accordance with some aspects, the method further comprises entering feedback provided by the second member regarding a pet of the first member into the pet care service market database and in some aspects, a feedback score is calculated, using a processor, based on the feedback provided by the second member and assigning the feedback score to the first member.

In accordance with some aspects of the method, the pet care service market database is linked to a computer based social networking service and accessible from the social networking service and in some aspects, the method further comprises creating a group on the social networking service. In some aspects the first member is provided access to utilize an interface of the social networking service to search for members willing to provide the pet care service desired by the first member and who are members of the group and in some aspects, and in some aspects, who are linked to the first member by at most a threshold number degrees of separation on the social network. In some aspects of the method, a member is permitted to provide a referral to another member through the social network and in some aspects a referral is required before the pet care service marketplace will provide contact information for a service provider to a service requester.

In accordance with some aspects of the method, a profile is created in the social network for at least one pet of at least one member, and in accordance with some aspects of the method, the at least one pet is permitted to join a group on the social network. In some aspects, the profile of the at least one pet includes information related to the pet including at least one of at least one other pet the at least one pet has interacted with in the past, comments of members regarding the pet, a feedback score of the member to which the pet belongs, and pet care services which the member to which the pet belongs desires to have performed for the pet and in some aspects, a member to whom the at least one pet belongs is permitted to permitted to accept or extend friend requests to at least one other pet on the social network.

In accordance with some aspects of the method, facilitating communication between the first member and the second member comprises at least one of providing the first member with an e-mail address through which to contact the second member and providing the second member with an e-mail address through which to contact the first member. In some aspects, anonymous e-mail addresses are assigned to members of the pet care marketplace, and in some aspects, new anonymous e-mail addresses are assigned to members of the pet care service marketplace for each transaction.

In accordance with some aspects of the method, facilitating communication between the first member and the second member comprises at least one of providing the first member with a telephone number through which to contact the second member and providing the second member with a telephone number through which to contact the first member. In some aspects, a telephone number provided is a telephone number of an electronic message mailbox and in some aspects, new telephone numbers are assigned to members of the pet care service marketplace for each transaction.

In some aspects, the method further comprises providing a dispute resolution mechanism. In some aspects an operator of the pet care service marketplace acts as a moderator to facilitate resolution of disputes among members, and in some aspects members of the pet care service marketplace serve as moderators in exchange for pet care service points. In some aspects, the method further comprises providing a forum for the resolution of disputes between members and operators of the pet care service marketplace.

According to one aspect of the present invention, computer-readable media having computer-readable signals stored thereon that define instructions that, as a result of being executed by a computer, instruct the computer to perform a method for matching pet care service providers with pet owners. The computer-readable media include separate computer-readable media with signals stored thereon for performing each individual element of the computer implemented methods described above, and computer-readable media for performing the method elements described above in any combination.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a table illustrating a method of calculating a point value for a pet care service;

FIG. 2 is a flowchart of a method of performing a pet care service match in accordance with an embodiment of the present invention;

FIG. 3 is a block diagram of an example system for performing pet care service matching according to one embodiment of the present invention;

FIG. 4 is a block diagram of an example system for performing pet care service matching according to an embodiment of the present invention;

FIG. 5 is a block diagram of an example system for performing pet care service matching according to an embodiment of the present invention;

FIG. 6 is a flowchart of a method of matching pet care service providers with pet owners in accordance with an embodiment of the present invention;

FIG. 7 is a flowchart of a method of operating a pet care service marketplace in accordance with an embodiment of the present invention; and

FIG. 8 is a flowchart of a method of assigning a point value to a pet care service in accordance with an embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

A pet care service marketplace in accordance with one or more embodiments of the present invention facilitates the exchange of pet care services between members of the pet care service marketplace. According to one embodiment, services are exchanged without the exchange of money. Rather, when a first member performs a pet care service for a second member, the first member earns pet care service points. An operator of the pet care service marketplace acts as a pet care service point “banker,” deducting pet care service points from an account of a member who has received a service and crediting them to an account of a member who has provided that service.

An operator (or operators) of the pet care service marketplace would establish membership in the marketplace for a plurality of pet owners and seek to match members interested in procuring pet care related services with other members by allowing members to “trade” services. An example of a pet care service that may be traded is pet boarding: members who wish to board their pet—not wishing to use the services of a paid pet sitter or kennel—would be able to trade pet-sitting services without paying each other in conventional currency. Pet owners would earn points for the pet boarding they perform and would be able to redeem such points by having other members perform pet care services for them. Exemplary pet care services which the pet care service marketplace would facilitate trade in would include but not be limited to the following:

Pet boarding: For example, if a member of the pet care service marketplace had to leave home for three days on business and needed another member to watch his dog for those three days, he could first perform three days of pet-sitting (or other pet care services) for other members, thus acquiring or earning points sufficient to allow him to place his dog with another member for three days. When the member places his dog with another member for those three days, he would “spend” his points.

Dog walking: Members who are able to walk other members' dogs would be matched. For example, if a first member is available to walk another member's dog in the mornings along with the first member's dog, and the other member is able to walk the first member's dog in the evenings along with his dog, the two members would be matched and perform the dog walking services for each other. Services of equivalent value, such as dog walking of comparable dogs could be traded directly without the need for the transfer of any payment or of any pet care service points.

Doggy Daycare: Member who provides daytime pet sitting services would be awarded points for such services.

Embodiments of the pet care service marketplace would facilitate trade in pet care services for any type of pet for which there is a market for services. The pet care service marketplace would not be limited to services for dogs and cats, but could also include services for fish, reptiles, birds, or other pets. For example, the pet care service marketplace would facilitate trade in such unusual services as bird sitting, guinea pig grooming, and iguana pedicures if the members of the marketplace expressed a desire to trade such services.

Prospective members would seek membership in the pet care service marketplace by filling out an application, either in paper form or on-line. The application would request prospective members to supply information relating to, for example, what types of pet care service(s) they desire, and/or what types of pet care service(s) they are willing to perform. The application would also request information related to the prospective members' pet or pets, including, for example, pet type, pet breed, pet gender, pet age, whether the pet is neutered, a description of the personality of the pet, a description of the friendliness of the pet toward other pets, a description of the friendliness of the pet toward people, pet energy level, pet size, pet diet requirements, preferred brand of food or type of treat, and pet special needs. The application may also request information such as whether any special equipment is required to perform a particular service for the pet and whether the pet owner would be able to supply such equipment.

Information related to the prospective member may also be requested, such as the prospective member's address and the geographic area he or she would be willing to travel to obtain or provide pet care services, what experience the prospective member has in providing pet care services, whether the prospective member was in possession of any special equipment that might be required for performing certain pet care services (e.g. shears and/or pet shampoo for performing grooming services), and information sufficient to allow the operator of the pet care service marketplace to perform a criminal background check and/or a credit check on the prospective member. Such information may include employment history, length of residency at a present address, whether the member owns or rents his living area, the member's salary and debt level, etc.

Once the prospective member submits the application form, and in some examples, pays a membership fee for joining the pet care service marketplace, the prospective member is granted membership status. In some examples, a periodic (e.g. monthly) service fee would be paid by members to remain members of the pet care service marketplace. In some examples, the grant of membership status may be contingent on the prospective member passing a criminal background and/or credit check. In some examples where background checks are performed on prospective members, the pet care service marketplace operators may offer a guarantee of the ability and/or trustworthiness of members whose backgrounds had been checked. In at least one example, this guarantee is provided for a fee or an enhanced number of points may be charged for services provided by members who had passed background checks.

Once the prospective member is granted membership status, a profile is created for the member. The profile would include the information provided by the member in the member's application, and would in one example be stored in a computer database. The database would reside on one or more computer servers and be accessible to members via the internet. The amount of pet care service points accumulated by each member would also be included in the database, although in some examples, a separate database would be used for tracking member points.

A profile may also be created for the member's pet or pets. A profile for a pet would include such things as the information regarding the pet provided on the membership application, and could be updated with comments of members who interact with the pet. In some examples, a reputation and/or feedback score would be assigned to the pet in the pet's profile, and in some examples, this reputation and/or feedback score would be adjusted based upon feedback from members interacting with the pet.

After completion of the creation of a profile for a member and/or a member's pet, a point value would be assessed for the pet care service or services the member desires. In some examples, the point value for a service that the member desires would be assessed responsive to a request entered by that member for someone to perform the service. The point value of these desired services would be determined based upon a baseline value for the particular service type, and in some embodiments adjusted by factors such as the difficulty of performing the service based upon the characteristics of the pet for that particular member. For example, in one service valuation system according to the present invention, dog sitting for one night would have an associated point value of 100 points. However, if a particular member has a dog that the member's or the pet's profile indicates is ill-tempered or that is not house trained, or that has special needs, the point value for house sitting that member's dog would be adjusted to, for example 125 points. On the other hand, if a member's profile indicates that they have a dog that is well behaved and friendly, a point value associated with house sitting that member's dog would be decreased, in one example, to 90 points. Adjustments to the point value of a service for a particular pet may be made on a periodic basis, for example, once per month, or dynamically. Dynamic adjustment would occur as the pet or the pet's owner accrued different feedback or reputation scores, or as changes to the profile of the pet or member occurred. Adjustments to the baseline value of a particular type of pet care service would in some examples also be performed on a periodic basis, such as once per month, or once per quarter based upon factors including, but not limited to, market supply and demand for the type of service.

In a similar manner, in some examples, a point value for a service which a member is willing to perform would be assigned. The assignment of the point value would be performed at the time the member indicates that he is willing to perform that service, or in some examples, after another member requests that the service be performed by the member willing to perform the service. In some examples, the point value of the service the member is willing to perform may be based upon a baseline point value for the type of service (e.g. dog walking vs. cat sitting) and in some examples adjusted upward or downward based upon factors that may include such things as a reputation and/or feedback score of the member willing to perform the service, the difficulty of performing the service, the distance the member would have to travel to perform the service, the experience of the member in performing similar services, etc. In other examples, a member willing to perform a service would be permitted to bid an amount of points he would be willing to accept for performing a service which another member had requested. This would permit the requesting member to have the option of choosing a lowest cost provider, or at least to take into account the amount of the bid in choosing a service provider from among those willing to perform the service requested.

In some examples, baseline point values for various pet care services traded in the pet care service marketplace are established by the operators of the marketplace. In one example, the baseline point value for a service is established in response to a survey conducted by the operators of the marketplace in which members or potential members would indicate how many points they would be willing to accept or pay for a particular service. In some examples, this survey is included in a membership application. In another example, the pet care service marketplace offers auctions for services between members. In some examples, pet care service auctions would be performed though a computer-based interface coupled to a computer associated with the pet care service marketplace. A baseline point value for a type of service would be based upon a historical average or median of what point value that type of service or a similar service commanded in auctions.

When a member desires a certain pet care service to be provided, he would access the database of the pet care service marketplace and perform a search for members willing to provide that service. In one example, the search is performed by a member by using a browser on a computer connected to the internet to access a web site associated with the pet service marketplace and entering search criteria. The entry of search criteria is in some aspects of the method streamlined by the inclusion of drop down menus and/or clickable soft buttons or other forms of prompts for information. The member would have the ability to specify search criteria such as location, threshold feedback rating, and experience level of a prospective pet care service provider. The search would return identifying information related to members willing to perform the desired pet care service, including contact information such as an e-mail address or a telephone number. In one example, the contact information would include e-mail only and the e-mail would in some examples be an anonymous e-mail address set up by the pet care service marketplace operators, unassociated with a member's personal e-mail address. This would help to protect a member's anonymity if he/she so desired. In another example, the contact information would include a telephone number only and the telephone number would in some examples be an anonymous telephone number set up by the pet care service marketplace operators, unassociated with a member's personal telephone number and/or a telephone number of a message system associated with the pet care service marketplace.

In another embodiment, member profiles would not need to be created, but rather a member could simply post a request for a service to a message board in the pet care service marketplace database. One or more service providers could search the message board and initiate communication with the requesting member to negotiate terms of providing the service. In some examples, access to the message board or to portions thereof may only be granted to members meeting certain criteria. In one example, access to the message board would be restricted to members not having criminal records. Criteria for access to certain bulletin board entries could in some examples be defined by the member posting the particular entry. In some examples a member could post a request for a service but restrict access to that request to members having a certain amount of experience or a certain threshold feedback level. The pet care service marketplace in some examples would serve as an intermediary to introduce the service requester to the service provider(s) and facilitate communications between the parties.

In one example, the member desiring the pet care service would contact the member willing to perform the pet care service to make arrangements for the service to be performed. In another example, a computer system associated with the pet care service marketplace would send the service requester's information to multiple members willing to provide the particular service requested, await responses from the members willing to perform the particular service with regard to whether they would be willing to perform this particular instance of this service, and in some examples, for how many points, and then forward the requesting member a list of members willing to perform the service. The member requesting the service could then choose from among the list of members willing to perform the service. In some examples, either or both of a member requesting a service and a member who has indicated that he is willing to provides such a service would have the option in a particular instance of indicating that they are not interested in being matched for the performance of a particular instance of a service. In some examples, one or both of the service requesting or service providing members could adjust a matching criteria to establish threshold values for acceptable matches. For example, a member may not wish a service to be performed by a member having a criminal background. In another example, a member owning a cat could specify that he would not be willing to have services performed by a member who owned a dog. Acceptable threshold criteria for matching a service requester with a service provider could be recorded permanently or semi-permanently as part of a member's profile, or could be specified by a member as part of an individual service request.

Once the pet care service was performed the performing member would report completion of the service and pet care service points would be debited from the requesting member's account and deposited to the performing member's account. In some examples, the service receiving member would have to confirm that the service was performed before the transfer of points occurred. In other examples, either the performing member, the requesting member, or both would be required to verify the performance of the service, for example by filling out a questionnaire pertaining to the service performed that in some examples could not be accurately filled out if the service had not been performed as reported. Reporting and confirmation of the performance of the pet care service would in some examples be performed over the internet by accessing and entering information into a web site maintained by operators of the pet care service marketplace, however in other examples, these acts may be performed by communicating with the pet cares service marketplace computers and/or operators by telephone, fax, mail, or other methods of communication.

In some examples, the point balance of a member may be allowed to go below zero. This could occur in instances such as when a new member who had accumulated few or no points desired a pet care service to be performed. After performance of the pet care service and transfer of points to the service provider, the member's point balance could go negative. In some examples, a limit would be placed on how negative a member's point balance would be allowed to drop, or in other examples how long a member would be allowed to maintain a negative point balance before being disallowed from receiving further pet care services or having his membership suspended or cancelled. In some examples, a provision for the elimination of a negative point balance may be supplied whereby a member is awarded pet care service points to cancel out his negative balance by committing to perform a service for another member. The accrual of a negative point balance would thus create an expectation and/or requirement for the member with the negative point balance to perform services to bring his point balance into non-negative territory. In some examples, accrual of a negative point balance would only be allowed upon a member providing a deposit of actual money to the pet care service exchange that would be returned upon the member's point balance going positive. This would provide incentive for a member to actually perform services to accrue points rather than cancelling membership in the pet care service marketplace while having a negative point balance. Another incentive that would be provided in some examples would be to assess a periodic service charge or maintenance fee upon members maintaining a negative point balance. Deposits, service charges or maintenance fees paid by members who subsequently quit their membership in the pet care service marketplace would in some examples become the property of the pet care service marketplace and in some examples could be used to purchase pet care service points to make up for the negative point balances of the departed members.

In some examples, the pet care service marketplace would include a procedure for auditing the points associated with the members of the marketplace. In some examples the audit would be performed in order to decrease the potential for the fraudulent accrual of points. The total points of all members in the system could be compared against the number of points transferred in all recorded transactions to see if they match. For example, in some embodiments where points could only be earned or spent for the provision or receipt of pet care services, i.e. no points would be given away or could be purchased for cash, the total number of pet care service points among all members in the system (after accounting for members who had quit and been removed from the system with positive or negative point balances) should sum to zero, with some members having negative points balances and others having positive points balances. A non-zero total number of points in the system would indicate that points were somehow being non-legitimately accrued or spent.

In other examples, the audit would check for unusually high or unusually low numbers of points being transferred for services. In further examples, the audit could flag instances of a suspicious number of transactions between a pair or a group of members. The threshold at which a warning would be produced by these audits would be set by the operators of the pet care service exchange and/or by an artificial intelligence program running on a computer associated with the pet care service marketplace. Members who exhibited unusual or suspicious point transfers would be investigated, and suspended from participation in the marketplace if fraudulent activity was confirmed.

In some examples, the service receiving member, the service performing member, or both would be able to provide comments on services performed. These comments would be added to the profile of the member commented on and would be accessible by other members of the service. In another example, these comments would be viewable on a profile created for the member's pet. Comments could be positive or negative. For example, a pet owner might post a comment that “the service provider was late picking up my dog for his walk” or a pet service provider might comment “this dog is very excitable and difficult to walk.”

In some examples, the profile of a member would include an indication of the rate at which the member accepted invitations to perform a pet care service. In some examples, a computer system associated with the pet care service marketplace would track the number of service requests that were presented to the member which matched a type of service which the member had indicated that he was willing to perform, and also track the number of times the member accepted or indicated willingness to perform the particular instance of the service requested. A low rate of service request acceptance would in some examples lower a reputation, feedback, or reliability score of the member.

In additional examples, the service receiving member, the service performing member, or both would be able to provide a feedback score based on their experience with one another. In some embodiments, the feedback score would be in a range of minus to positive ten, with minus ten being given for terrible service provided or received and positive ten for exceptional service provided or received. Alternatively, feedback could be characterized as good, bad, or neutral, with a feedback score being adjusted upward by one point for receipt of positive feedback, downward by one point for the receipt of negative feedback, and unaffected by the receipt of neutral feedback. In other embodiments a feedback score could be calculated from a form with a service provider and/or service receiver would fill out subsequent to completion of the performance of the service. The form would include sections for ranking separate aspects of the service such as the friendliness and/or manageability of the pet, the timeliness of the pickup and/or delivery of the pet, the quality of the service received, etc. In one example, to facilitate calculation of a feedback score based upon these multiple criteria, each of the criteria would be rated on a numerical scale, for example, from a low of zero to a high of ten.

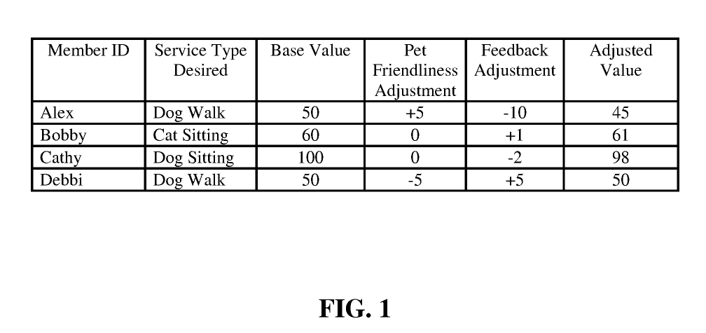

The feedback scores given to a member would accumulate over time and in some examples would be utilized as a factor in assessing a point value of a service. In some examples, the point value for a particular service for a particular member would be assessed by a computer program associated with the pet service marketplace. For example, referring to FIG. 1, which is a table of a possible point assessment scheme, both members Alex and Debbi have dogs for which they wish to have a member provide dog walking services. The dog walking service has a base value of 50 points. In this example, the base value for pet care services would have been previously established by the operators of the pet care service marketplace. Alex may have indicated that his dog is ill-tempered and Debbi may have indicated that her dog is very friendly. Thus, the dog walking service for Alex would “pay” more points, for example 5 more points than the base service point value, and the dog walking service for Debbi would “pay” fewer points, for example 5 fewer points than the base service point value. This would be because it would be less difficult to walk a friendly dog than an ill-tempered dog. The amount of adjustment to the service point value based upon pet temperament would in some examples be determined by the operators of the pet care service marketplace. In addition, Alex, or his dog may have proved easy to work with in the past and service providers may have given good feedback, thus earning Alex a 10 point credit based on his feedback score while Debbi may have received negative feedback from service providers in the past and thus the point cost of dog walking for her would be increased by 5 points. The final adjusted point value cost for dog walking for Alex would then be 45 points and for Debbi would be 50 points. In other examples, additional or different adjustment factors, such as size or age of a pet, pet special needs, or pet type or gender may also be included in a point allocation adjustment table similar to that of FIG. 1. Pet care service type point values could also be adjusted based upon market conditions. For example, if a particular service type had more people requesting the service than people willing to perform the service, the point value of the service would be increased. However, in some examples, pet care services would be assigned flat baseline point values which would not be adjusted based upon factors other than the type of service. In some examples, adjustments to a baseline service value would be made in terms of absolute numbers, for example, 5 extra value points would be assigned to a service to be performed for an ill-behaved pet. In other examples, adjustments to a baseline service value would be made in terms of a percentage adjustment factor, for example, a baseline service value would be reduced by 10% for a pet who had a positive feedback score above a threshold value, for example 5.

The service point value feedback adjustment could, but need not necessarily correlate directly with the feedback level of a particular member. For example, a member could receive a positive feedback level of ten and the point value of a service for that member might decrease by one point, but earning a positive feedback level of one hundred might decrease the point value of that same service by five points. In some examples, a change in a feedback score would result in a percentage reduction or increase in the point value of a service for a member. In some examples, the service point value adjustment algorithm would be constructed such that no combination of adjustment factors could result in a value for a particular service of zero or less.

In a similar manner that a point value may be assigned for a particular service desired by a particular member, a point value may be assigned for a service offered by a member. In some examples, a member offering dog walking services would have the point value of his service increased or decreased from a baseline amount based upon such factors as experience, whether the member has passed a background check or not, the member's reputation, and the member's feedback level. A member seeking a service could search the pet service market database for all members offering a service and use the amount of points a service provided by a particular member “costs” as a factor in deciding what member to request the service from.

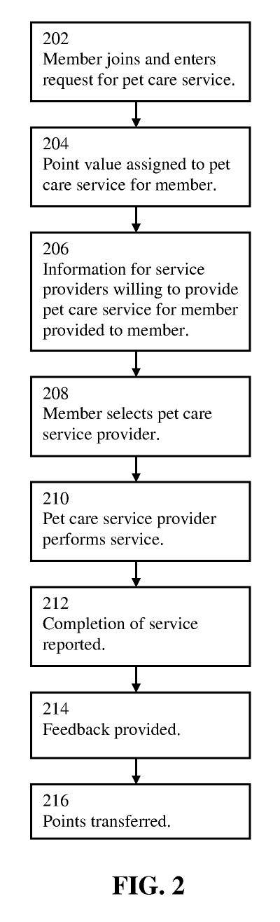

An embodiment of a method of performing pet service matching will now be described with reference to the flowchart of FIG. 2. In box 202, a member joins the pet care service marketplace. This may be done by filling out an application in paper form or online. As part of the application process the member may specify a particular service desired, although this information may also be provided at a later time after joining the pet care service marketplace. A particular service may be requested along with service provider search criteria such as location or service provider reputation. In some examples, a member may provide both required search criteria and preferred search criteria in their service requests. A computer system associated with the pet care service marketplace would use these required and preferred search criteria to produce a list of acceptable service providers matching all required search criteria and in some examples rank these service providers by how well each also fit the preferred search criteria.

In some examples, membership in the pet care service marketplace is contingent on a prospective member signing a waiver indemnifying the pet care service marketplace operators from damages resulting from harm that might befall their pet at the hands of another member.

In some examples, a fee is required to join the pet care service marketplace, and in other examples membership is provided free of charge. In some examples, upon joining, a lo member is given a number of startup points, for example 100 points that may be used to trade for pet care services in the pet care service marketplace. In other examples, a number of points is distributed to all current members of the marketplace on a periodic basis, for example 10 points per month. In further examples, accrued points would need to be used within a specified time limit, such as within three moths of accrual, or else they would become valueless and removed from the member's point balance.

After a request for a service is entered in box 202, in box 204 a point value is assigned for the particular service for that member. In one example, the point value is assigned by a computer algorithm performed on a computer maintained by the operators of the pet care service marketplace or associated with the pet care service marketplace as described above. In other examples, a member may post a point value the member is willing to “pay” for the particular service to be performed. In even further examples, the point value may be assigned as a result of an auction process where various members bid for the opportunity to perform the particular service desired by the requesting member.

In box 206, information regarding service providing members willing to provide the service requested is provided to the requesting member. The information provided may include information from the service providing members' member profiles, such as amount of experience, background check information, and feedback score. In one example, the amount of points that a service providing member is willing to accept for performing the service requested is also provided. In some examples, only information for members whose point value cost for providing the particular service requested did not exceed the point value assigned to the service for the requesting member would be provided to the requesting member.

In box 208, the requesting member selects from among the members willing to provide the service requested and contacts a member willing to provide the desired service to arrange for the service to be performed. In some cases, no service providing members may fit the search criteria entered by the requesting member. In these cases, the requesting member may return to box 202 and revise the search criteria or service requested and try again. In some examples a fee is required to be paid to the pet care service marketplace operators for providing the information regarding members willing to provide a pet care service for a member desiring the service. For example, a member may be required to enter a credit card number on a website in order to use the website to access the pet care service marketplace database, and a search fee may be charged to the credit card for each search performed. In some examples, this fee may be correlated to the point value of the service being requested, for example, one cent might be charged for every ten points of service value. This fee may be waived if no service providers are matched to a particular service request.

In box 210, the pet care service provider performs the service requested by the requesting member and once the service has been completed, the completion of the service is reported (box 212). The completion of the service is reported by the service provider, or in some examples, by the service receiver. In some examples the report of the completion of the service must be confirmed by both the providing and receiving member in order for the system to record the service as being completed. This will in some examples lessen the potential for fraud. At the time that completion of the service is reported, the service providing and/or service receiving member may also provide feedback on the service (box 214) although in other examples, this feedback may be provided at a later time.

After the completion of the service is reported, and in some examples, confirmed, the point value assigned for the service in box 204 is transferred from the service receiver's point account to the service providers point account. In some examples, this transfer takes place automatically. For example, the transfer may be initiated automatically by computer after the completion of the service is reported on a web site. If a point value assigned to the service for the member receiving the service was different from a point value requested from the member providing the service, if for example, an auction process was used to establish what a service provider would be willing to accept for performing the service, in some examples either the greater or the lesser of the two point values is transferred, and in some examples a rounded value of an average of the two different point values is transferred. In some examples, members will have the option of transferring some or all of the point value of a service in advance of the service being performed. In other examples, a service receiver would transfer points into an escrow account associated with the pet care service market prior to the performance of the service. The points would be released from the escrow account to the service provider upon verification of satisfactory completion of the service.

According to one aspect, an embodiment of the marketplace is designed to maintain an equilibrium of points. That is the positive balances of points held by members should equal negative balances of points held by members. In order to maintain this equilibrium in light of members who leave the service, deposits may be required for members who hold negative balances. In essence, the negative balance reflects and expectation of the marketplace that a service will be performed. The deposit operates as an incentive to the member holding a negative balance to perform that service. Additional incentives may be used. For example, a weekly service fee may be deducted from a deposit for a member with a negative balance. In one embodiment, the time period is adjustable, and in some embodiments variable. For example, a monthly service fee, becomes bi-weekly after two months, and weekly after two more periods. The time periods are definable by the marketplace operator, and should not be limited to the examples disclosed.

According to another aspect, the deposit requirement serves a dual purpose, it operates as an incentive to achieve a positive balance and operates as an equilibrium maintainer when a member with a negative balance leaves the marketplace. The expectation of service represented by the negative point value may be supplied by the operator of the system or provided for by the operator of the system, and any deposit may be used to offset any costs to the operator for having the service provided. Dealing with a member who leaves with a positive point balance is perhaps easier. While equilibrium is affected by a member leaving with a positive point value, having services provided that we will not be requested in turn leaves the system with additional resources. One should understand that equilibrium may include deviations from zero point balances across the system, and that a positive total balance may also reflect equilibrium.

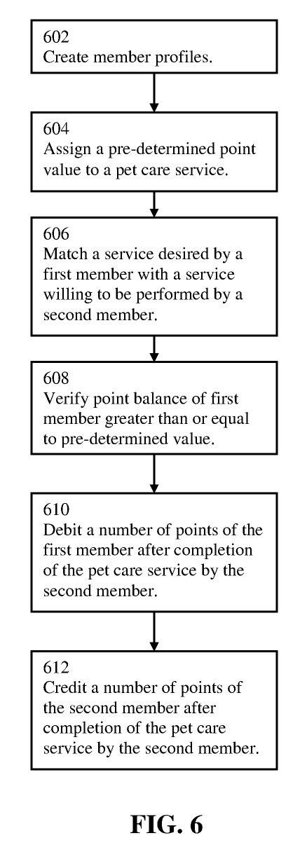

Referring to FIG. 6, there is illustrated a flowchart of a computer-implemented method of matching pet care service providers with pet owners. In box 602, profiles for members of the pet care service marketplace are created. In some examples, a profile for at least one member is created in response to a request to join the pet care service marketplace. In at least one example, these profiles are created and maintained in a computer database. The profile for each member would in some examples include information related to the member, such as pet care services he is willing to provide, or which he would like to have provided for his pet(s). The member profile in some examples would also include information such as the member's experience in dealing with pets or the member's preferences with regard to what types of pets the member is willing to provide services for. The member profile in some examples would also include information related to the member's pet(s) such as pet type, age, size, breed, etc. In some examples, the profile created would be a profile of a pet rather than a profile of a member who owned the pet.

In box 604, point values are assigned to pet care services. A list of pet care services to which point values would be assigned are in some examples created from the pet care services listed as desired or offered in the profiles of the various members. In other examples, the list of pet care services to which point values would be assigned would be generated by operators of the pet care service marketplace. In some examples, this list would include popular, easily definable pet care services such as dog walking, pet boarding, grooming, etc., and in some examples would not include all services offered or desired by the members of the marketplace. In some examples, the pet care services are assigned point values based at least upon the difficulty of performing the service. For example, a service of boarding a dog for a night would be assigned more points than a service of feeding a goldfish. In some examples, supply and demand for the different services would be a factor in assigning point values to the pet care services. For example, if many members offered dog sitting services, but very few offered cat sitting, while many members desired cat sitting and few desired dog sitting, cat sitting would be assigned a higher point value than dog sitting. The point values assigned would in some examples change with factors such as time of the year. For example, dog walking in the winter would be less pleasant to many people versus dog walking in the summer, so dog walking services in winter months would be assigned a higher point value than dog walking in summer months. In some examples, pet care services which are not assigned a specific value in box 604 would be assigned a value dynamically as a member desiring the service was matched to a member willing to provide the service. In some examples, the dynamic assignment of point values for these services would take into consideration factors such as difficulty of performing the service and amount of demand for the service requested when determining a point value. The assignment of point values and the adjustments to these point values would in some examples be performed manually, and in other examples be performed with the assistance of a computer programmed with a set of baseline pint values for different pet care services and/or the amount of change in point value to make to a particular service based on factors such as type of pet, time of day, day of week, time of year, etc.

In box 606, a service desired by a first member is matched with a service willing to be performed by a second member. In some examples, this matching is initiated by the first member entering a request for the service. The matching would in some examples result in a number of matches of members willing to perform the service requested. The requesting member would in some examples be provided with a list of members willing to perform the service and in some examples would have the option of choosing between potential service providers based upon personal preferences, or based upon criteria specified in advance. The matching of pet care service providers with members desiring services would in some examples be performed by a computer which would match factors such as desired service, geographic location, and/or reputation or feedback score of a member or a pet between pet care service providers and members desiring services. In some examples, the computer would provide a list of potential service providers to the requesting member with the list including a ranking of a best fit service provider to a worst fit service provider, the level of fitness determined based on criteria provided by the service requester. The requesting member would then choose from the list of potential service providers and make arrangements with a chosen service provider to have the pet care service performed. If no potential service providers appealed to the service requester he would not be obligated to choose any of them. Similarly, in some examples, a pet care service provider would have the right to refuse to provide service to a particular member or pet, even if the requesting member chose him to provide a service.

In box 608, after a match had been established between a member desiring a pet care service and a member willing to perform that service, and a point value had been assigned to that service, a point balance of the service requesting member would be verified to check if he had enough points to “pay” for the service to be rendered. In some examples, the total point balance for the member would not necessarily have to be greater than or equal to the predetermined point value or the dynamically assigned point value for the service. In these examples, the service requesting member would be allowed to overdraft his account to transfer the determined point value to the service provider after completion of the service. The amount of overdraft would in some examples be limited to a certain permissible account. In other examples, a member with an overdrafted points account would be charged overdraft fees in the form of, for example, either pet care service points or actual cash by the pet care service marketplace.

In box 610, after the pet care service has been performed a number of points corresponding to the point value of the pet care service assigned in box 604 (or the dynamically assigned point value in examples where a point value is assigned dynamically) is debited from the number of points belonging to the requesting member. Similarly, in box 612, this same amount of points is credited to the service provider. In some examples, a point account would be established in a computer database for each member of the pet service marketplace. In some examples, the transfer of points from a service receiver to a service provider would occur automatically upon an indication being provided to a computer on a network coupled to the computer holding the point database that the service requested had been completed. In further examples, the amount of points debited from the account of the service receiver would not match the amount of points credited to the service provider. This could happen for example in cases where the operators of the pet care service marketplace retained a number of points from the transaction as a form of transaction fee.

In accordance with a further embodiment, an example pet care service marketplace includes the following features:
No cash is exchanged between members.
The operators of the pet care service marketplace act as the “bankers” of pet care service points accrued or owed by members of the marketplace.
The point values for the various services available to members are proportional to the actual utility/value of such services.
Some members may have a positive accumulated pet care service point balance and some members may have a negative point balance. However, in one example, the sum of the total point balances of all members shall total zero. Thus, the combined expectation of service to be performed by all members shall be equal to the combined expectation of service to be received by all members. Members whose account point balances are negative shall be required to submit a deposit proportional to the size of the negative balance. This shall be the collateral for the work owed the membership body. The deposit shall be held by the operators of the pet care service marketplace. When pet care services are performed by a member with a negative point balance, thereby bringing the member's point balance into a positive range, the deposit shall be refunded. If the member quits while still holding a negative point balance, the deposit may be used to pay for pet care services for the other members. Thus, the combined expectation of service to be performed by all members shall continue to be equal to the combined expectation of service to be received by all members.
Members who continue to carry negative balances for more than 30 days will be assessed a charge, which will be applied against their deposit. This shall function as an incentive for such member to provide the pet care service(s) “owed” by such member to the membership. Other time periods may be used (e.g. weekly, monthly, quarterly, etc.)
Search results resulting from a member submitting a search for a pet care service provider are displayed using a “best fit” to “worst fit” system. Members may view search results by sorting the results based on various criteria, or various combinations of criteria. Any information in the system may be used in the sorting of criteria and in reports available to members and reports available to the operators of the marketplace.
Pet care service points will be automatically awarded to a service providing member if the service receiving member does not object.
Pet care service points earned by a member A for service provided to member B in City I may be used by member A to receive pet care services from any other member in any location. Thus, member A may move and use any points accumulated in member A's account to receive service from member C in City II.
Service requests will be posted on an electronic bulletin board.
Ratings/feedback scores will be presented in the form of “Doggie Bones.”
The operators of the marketplace may take any action necessary to regulate and promote efficient operation of the marketplace. Thus, the operators may audit point accounts and transactions, suspend members, expel members, add points and deduct points from members, track any/all information, and use any information acquired in any reports.
The operators of the pet care service marketplace shall resolve any disputes and be the final decision makers with respect to any issues or concerns related to the membership and the operation of the system.
The operators will use systems to directly debit and/or credit members' bank accounts, including the use of ACH debits and credits.

In other embodiments a pet care service marketplace may include features in addition to those above and in other embodiments would not include all features listed above.

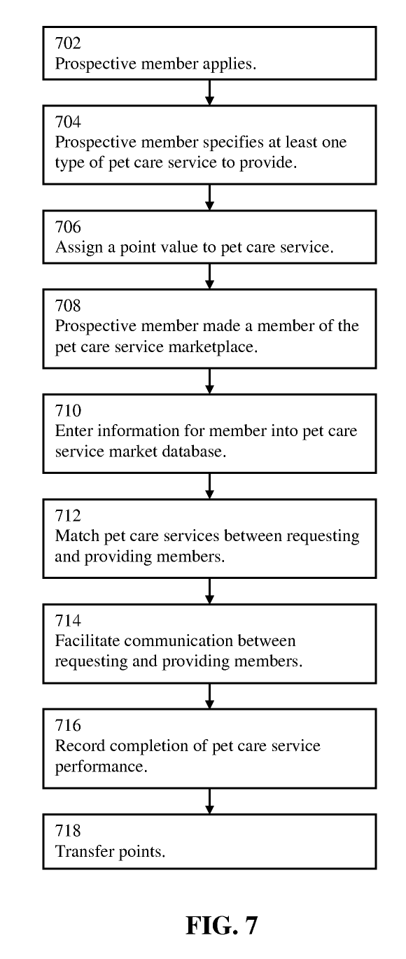

Referring to FIG. 7, there is illustrated a flowchart of a method of operating a pet care service marketplace. In box 702 a prospective member applies for membership in the pet care service marketplace. The member may apply by filling out and submitting a paper membership application, or alternatively by filling out an online application and/or questionnaire. In some examples, information that would be requested on the membership application would include biographical information such as the prospective member's address, driver's license number, criminal history, employer, and in some cases, age and sex. The application form would in some examples also request that the applicant provide information related to the type of pet or pets he owns and/or cares for including, for example, the type, breed, and age of the pets, the affinity of the pet(s) for other pets and/or people, any special needs the pet(s) might have, the vaccination status of the pet(s), and any special preferences for food, treats, or areas of play that the pet(s) might have.

In box 704, the prospective member specifies at least one type of pet care service he would be willing to provide to other members. The prospective member may choose this service from a pre-determined list of services that would be presented to the prospective member in for example, a drop down menu or selection box on an internet web site. Alternatively, the member could specify a type of service he is willing to provide in the absence of prompts.

In box 706, a point value is assigned to the pet care service(s) which the member specified he is willing to provide. In some examples, a baseline point value would be assigned at this point to any of a number of services available through the marketplace. This point value is in some examples determined based upon multiple factors such as difficulty of performing the service, demand for the service, experience of the prospective member in performing that service, or any of the other factors described above that could be taken into account in assigning a value to a pet care service. In some examples, the point value of the service is assigned a baseline value at box 706 which may in some examples be modified later in light of factors such as a member's feedback score. In other examples, the point value for the service is determined dynamically at a point when a service is requested and the member offers to perform the service.

In box 708, the prospective member's application is evaluated and if deemed acceptable, he is granted membership status in the pet care service marketplace. In some examples, the grant of membership is contingent on a payment of a fee to operators of the pet care marketplace. Prospective members could be denied membership for any of a number of reasons. For example, a prospective member could be denied membership in the pet care marketplace if he had a criminal record. A criminal record including a conviction for cruelty to animals would in some examples be particularly damaging to a prospective member's chances of being granted membership. Alternatively, if the service(s) that the prospective member is willing to perform are in over supply, he might be denied membership. In other examples, if the member's pet(s) were particularly difficult to handle or had a history of hurting other animals, pets or people, the member would be denied membership in the pet care service marketplace. Similar factors that could result in a prospective member being denied membership might also be considered as bases for revoking a member's membership after he had been granted membership.

In box 710, once a member has been granted membership status, information pertaining to that member is entered into a database associated with the pet care service marketplace. The information would in some examples comprise a profile of the member and/or the member's pet. The information would in some examples also include billing information for the member. Other types of information that would be entered into the database would in some examples include information related to the member's pet such as the pet's veterinarian's contact information. Information regarding what pet care service(s) the member would be willing to perform and in some examples, threshold criteria such as distance from the member's home or time of day during which the member would be willing to perform these services would also be entered into the database. Services the member desired to be performed for his pet(s) would also be entered into the database, although in other examples, service requests would be entered at a later time.

In box 712, pet care services requested by members are matched with pet care services which other members indicated that they were willing to perform. Members willing to provide a pet care service would in some examples be provided a list of all members requesting the service they were willing to provide who match criteria such as distance from the pet care service provider's home, or type or breed of pet that the per care service provider may have indicated. In other examples, a list of pet care providers willing to provide a particular service requested would be provided to the pet care service requester. These lists would in some examples include rankings of providers or receivers who are best matches for the particular pet, and/or member, and/or service requested. These lists in some examples would include information related to the pert care service provider or requester including such information as feedback and/or reputation score of the member or the member's pet. In examples where a pet care service requester specifies a maximum amount of points he is willing to spend to receive a particular type of pet care service, a list of service providers would include only service providers willing to perform the service for that amount of points or less. In examples where pet care service providers are permitted to bid points for performing a pet care service, the amount of points bid by members willing to provide the service that match the service requester's matching criteria would also be included in the list of pet care service providers provided to the service requester. In some examples, a pet care service requester would be able to specify how many bidders he would like to receive bids from. For example a pet care service requester could request bids for a service and request to be provided with information regarding only the lowest bidder, or in other examples, the ten lowest bidders.

In box 714, operators and/or automated systems associated with the pet care service marketplace would facilitate communication between pet care service providers and pet care service requesters. A pet care service requester would in one example choose from among a list of pet care service providers and request contact information for these providers. In some examples this contact information would be provided automatically with the list of potential pet care service providers. In other examples, a specific request for contact information for the pet care service providers would be made by the pet care service requester, for example, through a web site. The pet care service marketplace would provide contact information in the form of, for example, an e-mail address and/or a telephone number. In some examples, the e-mail address provided would be assigned by the pet care service marketplace and would not be the pet care service provider's true e-mail address. In some examples, these “alias” e-mail addresses are assigned when a member joins the pet care service marketplace, and in other examples, new random e-mail addresses are assigned to members for each transaction. The pet care service marketplace computers would forward messages sent to the provided e-mail address to the actual e-mail address of the service provider. In a similar manner an “alias” e-mail address of the pet care service requester would be provided to the pet care service provider so that he could respond to e-mails from the pet care service requester. In other examples, a phone number provided would be a phone number for a voice message mailbox which the service requester could leave a message for the potential service provider at and which the pet care service requester could leave response messages. In other examples, random phone numbers would be assigned to the pet care service provider and pet care service requester, either at the time of joining the pet care service marketplace, or at the time a transaction is being negotiated, which when dialed would result in the call being re-routed to the true phone number of the member. The service requester and potential service provider(s) would exchange communications and decide whether they wanted to continue with consummation of the exchange of the pet care service for pet care service points.

Once agreement is reached between a pet care service requester and a pet care service provider, the provider would perform the pet care service for the pet care service requester.

In box 716, completion of performance of the pet care service is reported. In some examples, reporting of completion of the service is accomplished by the service receiver recording completion of the service on a website associated with the pet care service marketplace. For example a service receiving member would in one example access a web site through a computer connected to the internet, access a personal account through that website, navigate to a page showing a list of open service requests and check a button to indicate the completion of one or more of the open service requests. In some examples, the service provider would report a completion of a pet care service, and in other examples, a completion of a pet care service would be acknowledged by both the service receiver and the service provider before the completion of the service is recorded in a computer system associated with the pet care service marketplace. In further examples, a pet care service provider, receiver, or both would be requested to validate the completion of the service by providing information that would not be readily available had the service not been performed. This information in some examples would consist of, for example, a password given by the service receiver to the service provider or vice versa, or a survey requesting specific information about the pet or the service performed. In other examples, completion of the service would be recorded in response to verification of the completion of the service by telephone, mail, fax, or other means of communication.

In box 716, feedback may be provided along with the reporting of completion of performance of the pet care service. In one embodiment, feedback is provided by the pet service receiver regarding the service provided by the pet care service provider, and in alternate embodiments, feedback is also provided by the pet care service provider based on such things as the behavior of the pet of the pet care service receiver. In some embodiments, feedback is characterized as positive, negative, or neutral. A positive feedback would increase a member's feedback score by one point, a negative feedback would decrease the member's feedback score by one point, and a neutral feedback would have no effect on the member's feedback score. In some embodiments, a feedback score would be characterized as overall good, bad, or neutral based on the numerical score. For example a total feedback score of 5 or above would be characterized as good, a total feedback score of −5 or below would be characterized as bad, and a feedback score between −5 and 5 would characterized as neutral. These feedback score characterizations would in some embodiments be used to adjust a point value for a pet care service to be provided or performed by a member.

In box 718, after the completion of the service is recorded, pet care service points are transferred between the receiving member and the service providing member. In some examples, the amount of points transferred would be the point value assigned to the service in box 706. In some examples, an amount of points would be debited from an electronic point account of the service receiver and deposited into a point account of the service provider. These point accounts would in one example reside on one or more databases associated with the pet care service marketplace. In some examples, a time limit is placed upon the amount of time after which a service agreement is made and when the completion of the service may be reported. In some examples, a computer system sends out reminders to service requesters and/or service providers who have been matched requesting that they indicate whether the service has been performed or whether the parties had decided to abandon the transaction.

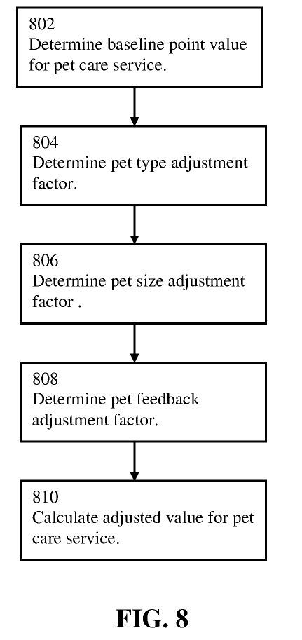

Although different baseline point values may be assigned for different types of pet care services, the difficulty of performing a particular service for a particular pet should be considered in establishing a difference between the actual point value of the service and a baseline point value. Illustrated in FIG. 8 is a method of assigning a point value to a pet care service. In box 802 a baseline point value for the service in question is determined. In some embodiments, baseline service values for available pet care services are pre-determined by the operators of the pet care service marketplace. In one example, 100 points would have been pre-assigned for a pet walking service, 200 points would have been pre-assigned for a pet sitting service (at a provider's location), 300 points for an overnight boarding service, and 250 points for grooming services (nail trimming, bathing, etc.). In box 804 an adjustment factor is determined based upon the type of pet. This adjustment factor in some examples would be an absolute point number adjustment based on the pet and service type, for example 10 extra points would be added to the baseline value for pet sitting a dog, while 10 points would be deducted from the baseline value for pet sitting a cat. In other examples, a percentage adjustment factor would be determined based on pet type and applied to a subset of, or in some examples, all potential services. For example, a percentage adjustment factor of 90% (0.9) would be applied to services for a cat, a percentage adjustment factor of 100% (1.0) (no adjustment) would be applied to services for a dog, and a percentage adjustment factor of 50% (0.5) would be applied to services for a bird. In box 806 a service value adjustment would be determined based on the size of the pet. For example, large pets would receive a +5% point value adjustment, while small pets would receive a −5% point value adjustment. In other examples, the pet size point value adjustment could be in absolute points as described above. A pet's size would be characterized in one example based upon a description of the pet provided by the pet owner, and in other examples, the pet's weight would be compared against an average weight for pets of the particular pet's breed and/or age to determine a characterization of pet size. In box 808 a service point value adjustment would be determined based on the feedback score of the pet. For example, a pet who had received an overall good feedback score level would have a −10% point value adjustment assigned, a pet who had received an overall bad feedback score level would have a +10% point value adjustment assigned, and a pet who had received an overall neutral feedback score level would have a 0% point value adjustment assigned. Again, as in box 804, in an alternate example an absolute point value adjustment would be determined based upon the type of service and the feedback score level instead of a percentage point value adjustment. Additional adjustment factors (not illustrated) would in some examples be similarly determined based upon factors such as the reported difficulty of a pet to work with and/or a reported friendliness factor for a pet. The magnitude of these adjustment factors would in some examples be determined by operators of the pet care service marketplace. In box 810, a final point value for the pet care service for the pet is determined. For example if the pet was a dog seeking a walking service which had been assigned a pet type adjustment factor of 1.0, a pet size adjustment factor of 0.9, a pet feedback adjustment factor of +10% (1.1), a difficulty adjustment factor of +5% (1.05), and a friendliness adjustment factor of −5% (0.95), the final value of the dog walking service for this particular dog would be calculated as (100)*(1.0)*(0.9)*(1.1)*(1.05)*(0.95)=98.75 points, which would be rounded to 99 service points.

In alternative embodiments, where participants are allowed to bid on services, a baseline point value for a particular type of service would be established based upon the bidding history for that type of service. In one example, historical bids and final accepted bid values for each service would be tracked and a statistical model for a point value for each service would be established. Based upon this statistical model, the baseline point value of the service would be adjusted. In one example the median or mean accepted bid point value for a service over a time period, such as the last three months would be calculated and periodically, for example, once every three months baseline point value for that service would be adjusted to match the median or mean accepted bid point value for the service. In another example, if the baseline point value for a service was determined to fall outside of a range determined by the mean plus and minus 1.5 standard deviations of the point value of accepted bids for that service, the baseline point value for the service would be adjusted to the calculated mean accepted bid value for that service. The value of the service for a particular pet would then be determined as described above.

It is contemplated that various examples of methods in accordance with the present invention may comprise the acts illustrated in any of FIGS. 2, 6, 7 and 8, as well as additional acts or replacement acts. It is also contemplated that not all acts illustrated need be performed in all examples, and that acts may be performed in alternate orders than illustrated.

In some examples a receiver of a pet care service might refuse to pay all or at least a portion of the point value of the pet care service rendered. This would occur in some examples if the pet care service receiver was dissatisfied with the quality of the service rendered. In some examples, a dispute resolution mechanism would be incorporated into the pet care service marketplace in order to facilitate the resolution of such disputes. An operator of the pet care service marketplace would in these examples act as a moderator to facilitate resolution of the dispute. In other examples, members of the pet care service market would serve as moderators. Moderators who are members of the pet care service marketplace would in some examples perform moderation services in exchange for pet care service points. These moderators would in one example be paid in pet care service points deducted from accounts of the members involved in the dispute. In some examples, pet care service points would be transferred from the member who lost the dispute to the moderator. In other examples, the moderators would be awarded pet care service points directly from the operators of the pet care service marketplace. In some examples, members would serve as moderators for the resolution of disputes between other members and the operators of the pet care service marketplace. In some examples, the operators of the pet care service marketplace would provide a forum for the resolution of disputes between members and other members and/or between members and operators of the pet care service marketplace, such as a dispute resolution section of a website.

In some embodiments, the operators of the pet care service marketplace would reserve the right to verify the veracity and accuracy of the services reported by members. The operators of the pet care service marketplace would reserve the right to take appropriate action to curb abuse and reasonably regulate the pet-related services performed by members acting within the scope of the pet care service marketplace. In some examples, operators of the pet care service marketplace would respond to repeated open disputes and/or complaints against a member by taking action such as docking points from a member's account, or even expelling him from membership in the pet care service marketplace. In some examples, the operators of the pet care service marketplace would provide a forum for impartial review of any disputes or complaints between members or between members and the operators of the pet care service marketplace. In some examples, the operators of the pet care service marketplace would be shielded from liability for the actions of members and/or from harm resulting from the expulsion or penalization of members by an agreement signed by members upon applying to become members in the pet care service marketplace.

The pet care service marketplace transactions including submitting an application to become a member and searching for a pet care service provider would in an exemplary example be performed through the internet on a web site maintained by operators of the pet care service marketplace.

In further examples, the pet care service market database may be linked with and accessible from a social networking website such as MySpace® or Facebook®. In some examples, a separate social network specific to the pet care service marketplace would be established. This social network would incorporate many features of social networks such as MySpace® or Facebook® such as the ability to create profiles with information such a photos, biological data, likes and dislikes, etc. and the ability to link as a “friend” to other profiles, to create groups to which members may subscribe and/or be invited to join, and allow for comments and feedback to be posted on one member's (or one member's pet's) profile by another member. An interface of the social network may be utilized by members to search for other members willing to provide pet care services which they desire. In some examples, limitations would be placed upon the group of members willing to provide services which a member desiring a service may search. For example, a group may be created by the operators of the pet care service marketplace on the social network, and only members who join this group or are invited to join this group may be searchable. Alternatively, a member may search for other members on the social network who are willing to provide a service desired by the member who are linked to the member by a certain number of “friend” connections, for example the service desiring member may search for service providing members who are connected by at most three degrees of separation from the service desiring member. In some examples, members may utilize the social networking service to provide referrals or recommendations of service providing members or service desiring members to other members, and in further examples a referral of a first member to a second member would be required prior to the initiation of communication between the first and second members. In some examples, members who referred a second member to a third member would receive pet care service points as a reward for referring a quality service provider if the referred member did a good job for the third member. This reward would in some examples be deducted from the amount of points transferred from the third member to the second member after completion of the service, and in other examples would be provided by the pet care service marketplace.

A member may set up threshold criteria to use when searching for a service provider on the social network or on other incarnations of the pet care service marketplace, and a service provider may set up criteria regarding service requesters he is willing to provide service for. For example, a member may specify that he is only willing to interact with other members who have a threshold feedback score or who have received positive feedback from a threshold number of other members. In another example, the member may specify that he is only willing to interact with members belonging to specific social networking groups.

In some examples, a profile on the social network may be a profile of a pet, rather than a profile of a member to which that pet belongs. In these examples the member to whom the pet belongs may be permitted to add the pet to a group created on the social network. In some examples, the group would be created by an operator of the pet care service marketplace, by a member of the pet care service marketplace, by another person, or automatically by a computer or computer network hosting the social network. A member to whom a pet having a profile on the social network belongs may in some examples be permitted to accept or extend friend requests from the pet to at least one other pet on the social network. Profiles of pets on the social network may include information related to the pet. This information may include such things as a listing of other pets that the pet has interacted with in the past and in some examples comments related to those interactions, provided by either the owner of either the pet or owner(s) of the pet(s) with which the pet has interacted. The profile of the pet may also include information such as comments of members regarding the pet, a feedback score of the member to which the pet belongs, and pet care services which the member to which the pet belongs desires to have performed for the pet.

Members who wish to participate in the pet care service marketplace but who do not own a computer or an internet connection may participate by other means, such as requesting a service by telephone, or by filling out a paper form and receiving a list of members willing to provide a service by telephone, fax, through the mail, or by other delivery means.

In some examples, the pet care service marketplace may facilitate the trade of pet care services without the transfer of money or goods between members. Points earned for performing services would be redeemable only for other services—no money would trade hands between members. However, in alternate examples, accumulated points may be redeemable for goods at a sponsoring organization such as a pet store or may be utilized to pay membership or search fees. In some examples, the pet care service marketplace would offer pet related products that members could “purchase” with pet care service points. In further examples, pet care service points would be available for purchase with actual money from the pet care service marketplace.

In some examples, any member who has earned pet care service points could redeem them by requesting the service of any other member in any other location. Thus, if a member moves during his/her membership period, he may transfer the value earned to any other location.

Various embodiments according to the present invention may be implemented on one or more computer systems. These computer systems may be, for example, general-purpose computers such as those based on Intel PENTIUM-type processors, Motorola PowerPC, AMD Athlon or Turion, Sun UltraSPARC, Hewlett-Packard PA-RISC processors, or any other type of processor, including processors with multiple cores. It should be appreciated that one or more of any type computer system may be used to facilitate an operation of a pet service exchange marketplace according to various embodiments of the invention. Further, the system may be located on a single computer or may be distributed among a plurality of computers connected by a communications network.

A general-purpose computer system according to one embodiment of the invention is configured to perform any of the described functions, including but not limited to creating a member profile, creating a database of member profiles, assigning a point value to a pet care service, matching a service desired by at least one member with a service willing to be performed by at least one other member, debiting a number of points of at least one member, crediting a number of points of at least one member, maintaining a point account for at least one member, providing a list of members willing to perform a service desired by a first member to the first member, facilitating the choosing by a first member a member to provide the desired service from the list provided, facilitating communications between the first member and the chosen member, providing a mechanism through which the first member may choose to accept or reject the service of the chosen member, facilitating the rating by at least one member of the pet care service provided by at least one other member, making the rating of at least one member available to at least one other member, maintaining a reputation and/or feedback score of a member, altering a reputation and/or feedback score of a member, facilitating the bidding of points for services, matching at least one member with all members matching a set of criteria provided by the at least one member, facilitating the selection by one member a member to provide the pet care service desired by the member from the members matching the set of criteria provided by the member, receiving from a prospective member an application for membership in the pet care service marketplace, receiving information regarding at least one type of pet care service the prospective member would be willing to provide, making the prospective member a member of the pet care service marketplace, recording a completion of the pet care service by a member, collecting a membership fee from members, collecting a service fee for matching a first member with a second member, receiving from a prospective member a waiver of liability associated with a pet service, performing a background check on a prospective member, performing a credit check on a prospective member, entering feedback provided by a first member regarding a service performed by a second member, calculating a feedback score for a member, adjusting the point value assigned to the type of pet care service utilizing criteria including the feedback score of the second member, etc., and the invention is not limited to having any particular function or set of functions.

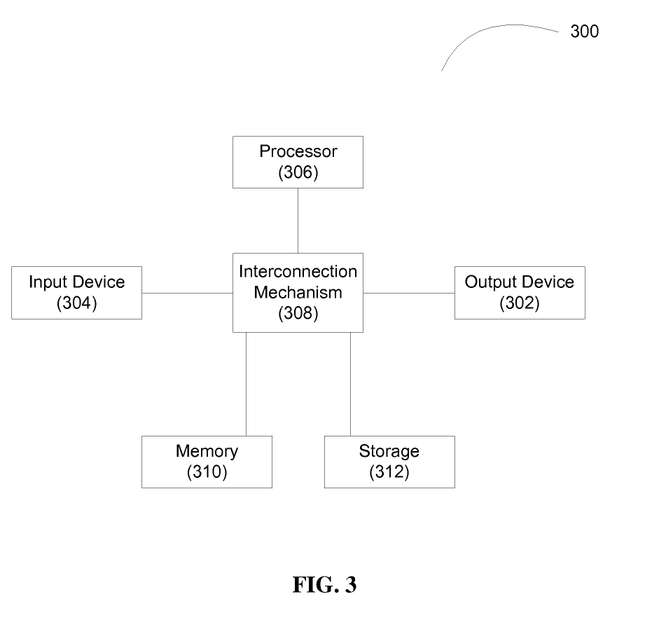

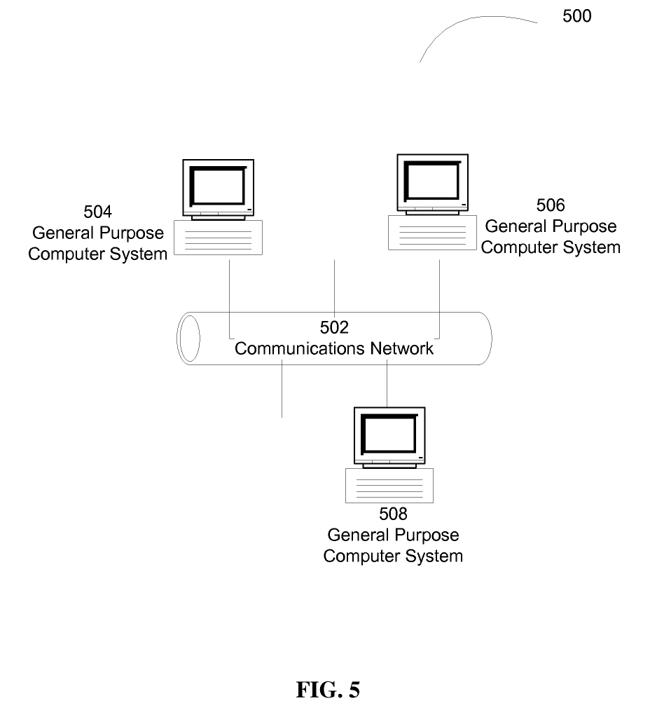

FIG. 3 shows a block diagram of a general purpose computer system 300 in which various aspects of the present invention may be practiced. For example, various aspects of the invention may be implemented as specialized software executing in one or more computer systems including general-purpose computer systems 504, 506, and 508 communicating over network 502 shown in FIG. 5. Computer system 300 may include a processor 306 connected to one or more memory devices 310, such as a disk drive, memory, or other device for storing data. Memory 310 is typically used for storing programs and data during operation of the computer system 300. Components of computer system 300 may be coupled by an interconnection mechanism 308, which may include one or more busses (e.g., between components that are integrated within a same machine) and/or a network (e.g., between components that reside on separate discrete machines). The interconnection mechanism enables communications (e.g., data, instructions) to be exchanged between system components of system 300.

Computer system 300 may also include one or more input/output (I/O) devices 304, for example, a keyboard, mouse, trackball, microphone, touch screen, a printing device, display screen, speaker, etc. Storage 312, typically includes a computer readable and writeable nonvolatile recording medium in which signals are stored that define a program to be executed by the processor or information stored on or in the medium to be processed by the program.

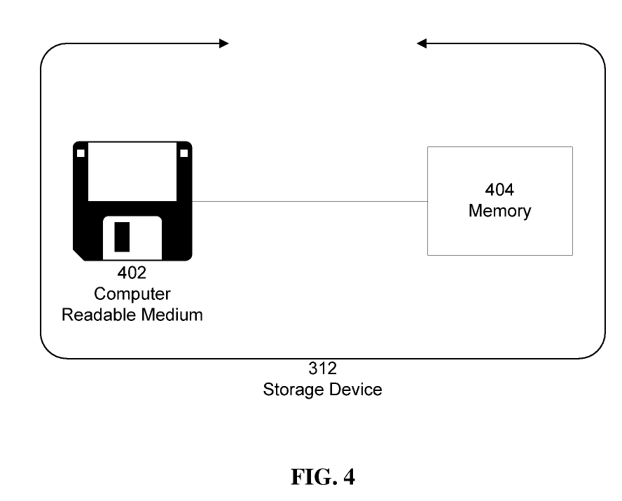

The medium may, for example, be a disk 402 or flash memory as shown in FIG. 4. Typically, in operation, the processor causes data to be read from the nonvolatile recording medium into another memory 404 that allows for faster access to the information by the processor than does the nonvolatile recording medium. This memory is typically a volatile, random access memory such as a dynamic random access memory (DRAM) or static memory (SRAM).

Referring again to FIG. 3, the memory may be located in storage 312 as shown, or in memory system 310. The processor 306 generally manipulates the data within the memory 310, and then copies the data to the medium associated with storage 312 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architectures or components that that shown in FIG. 3.

Computer system 300 may be a general-purpose computer system that is programmable using a high-level computer programming language. Computer system 300 may be also implemented using specially programmed, special purpose hardware. In computer system 300, processor 306 is typically a commercially available processor such as the well-known Pentium class processor available from the Intel Corporation. Many other processors are available, including for example, multi-core processors. Such a processor usually executes an operating system which may be, for example, the Windows-based operating systems (e.g., Windows Vista, Windows NT, Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used. Various examples of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various examples of this system can be implemented by one or more systems similar to system 300. For instance, the system may be a distributed system (e.g., client server, multi-tier system) comprising multiple general-purpose computer systems. In one example, the system includes software processes executing on a system associated with an operator of pet care service marketplace, or in another example, a member of the pet care service marketplace (e.g., a client computer system). As discussed, these systems may be distributed among a communication system such as the Internet. One such distributed network, as discussed below with respect to FIG. 5, may be used to implement various aspects of the present invention.

FIG. 5 shows an architecture diagram of an example distributed system 500 suitable for implementing various aspects of the present invention. It should be appreciated that FIG. 5 is used for illustration purposes only, and that other architectures may be used to facilitate one or more aspects of the present invention.

System 500 may include one or more general-purpose computer systems distributed among a network 502 such as, for example, the internet. Such systems may cooperate to perform functions related to the pet care service marketplace. In an example of one such system for conducting a matching of services among members, one or more members operate one or more client computer systems 504, 506, and 508 through which requests for a service is submitted, and where providers of services may use one or more client computer systems 504, 506, and 508 to submit a desire to perform the service or a bid to perform the service. In one example, any service providers and any service receivers interface with the system via an internet-based interface.

In one example, a system 504 includes a browser program such as the Microsoft Internet Explorer application program through which one or more websites may be accessed. Further, there may be one or more application programs that are executed on system 504 that perform functions associated with the pet care service marketplace. System 504 may include one or more local databases including, but not limited to, information relating to pet care services which members are willing to perform, pet care services which members desire, member points, and member feedback ratings.

Network 502 may also include, as part of the system for operating a pet care service marketplace one or more server systems, which may be implemented on general purpose computers that cooperate to perform various functions of the system for operating a pet care service marketplace. System 500 may execute any number of software programs or processes and the invention is not limited to any particular type or number of processes. Such processes may perform the various workflows associated with a system for operating a pet care service marketplace.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of facilitating system-wise reciprocal exchange of pet care services by member pet owners, the method comprising acts of:
creating a member profile of at least one member in response to a request to join the pet care service marketplace;
determining, by a processor, a pre-determined point value of a pet care service, wherein the point value is proportional to the actual utility of the service;
assigning the pre-determined point value to the pet care service;
matching, by a processor, a service desired by the at least one member with a service willing to be performed by at least one other member;
debiting a number of points of the at least one member after a transaction for the pet care service; and
crediting a number of points of the at least one other member after a transaction for the pet care service.

2. The method of clam 1, further comprising an act of maintaining an equilibrium of points within the pet care service marketplace, wherein the act of maintaining includes an act of restoring the equilibrium of points in response to a member leaving the system.

3. The method of claim 1, further comprising an act of permitting one or more members of the pet care service marketplace to have a negative number of points, wherein the negative number of points reflects an expectation of services to be performed by the member.

4. The method of claim 3, further comprising an act of requiring a member pay a deposit as a condition for permitting the member to have a negative point balance.

5. The method of claim 3, further comprising an act of charging a service charge against a member having a negative number of points for more than a predetermined period of time.

6. The method of claim 1, wherein the at least one other member has a member profile indicating at least one pet care service the at least one other member is willing to provide.

7. The method of claim 1, further comprising an act of providing a list of members willing to perform a service desired by a first member to the first member through a website.

8. The method of claim 1, further comprising an act of determining that the service receiving member did not object, and wherein the act of crediting a number of points of the at least one other member after a transaction for the pet care service occurs automatically in response to the act of determining.

9. The method of claim 1, further comprising an act of governing communications between a first member and a second member over a communications network, by requiring communication first occur through a central communication system controlled by a marketplace operator.

10. The method of claim 1, further comprising:
an act of including in the member profile of the at least one member a type of service the at least one member desires to have performed; and
an act of assigning, by a processor, a point value to the service the at least one member desires to have performed.

11. The method of claim 10, wherein the act of assigning a point value to the service the at least one member desires to have performed comprises assigning a value based at least in part upon a baseline point value for a class of pet care services.

12. The method of claim 1, further comprising:
an act of allowing the at least one member to rate the pet care service provided by the at least one other member; and
an act of making the rating of the at least one member available to at least one additional member.

13. The method of claim 1, wherein determining, by a processor, a pre-determined point value of a pet care service includes providing the processor with a point value assigned by the at least one member.

14. The method of claim 1, wherein matching the at least one member with at least one other member includes an act of matching the at least one member with all members matching a set of criteria provided by the at least one member.

15. A method of operating a pet care service marketplace, the method comprising acts of:
receiving from a prospective member an application for membership in the pet care service marketplace;
providing for entry of information associated with the application into a user interface displayed on a computer;
calculating, using a processor, a point value for at least one type of pet care service available through the marketplace;
assigning the point value to the at least one type of pet care service available through the marketplace;
generating a computer record for the prospective member;
entering information associated with the member into a pet care service market database, the database residing on at least one computer, wherein the information associated with the member includes at least one of the at least one type of pet care service the member would be willing to provide and a type of pet care service the member desires;
matching, using a processor, a pet care service desired by a first member with a pet care service which a second member in the pet care service market database is willing to perform;
facilitating communication between the first member and the second member, wherein facilitating communication includes an act of communicating over a communications network operated by the marketplace;
completing a request for service;
debiting a number of points of the first member in response to the act of completing a request for service by the point value of the pet care service provided; and
crediting a number of points of the second member in response to the act of completing a request for service by the point value of the pet care service provided.

16. The method of claim 15, further comprising an act of collecting a membership fee from members.

17. The method of claim 15, further comprising an act restricting members from exchanging money for services.

18. The method of claim 15, further comprising an act of entering feedback provided by the first member regarding a service performed by the second member into the pet care service market database.

19. The method of claim 18, further comprising:
an act of calculating, using a processor, a feedback score based on the feedback provided by the first member; and
an act of assigning the feedback score to the second member.

23. The method of claim 19, further comprising an act of adjusting the point value assigned to the type of pet care service utilizing criteria including the feedback score of the second member.

24. The method of claim 15, wherein the point value assigned to the type of pet care service is determined utilizing criteria including at least the difficulty of and/or the utility associated with providing the type of pet care service.

25. The method of claim 15, wherein the pet care service market database is linked to a computer based social networking service and accessible from the social networking service.

26. The method of claim 15, further comprising and act of providing a dispute resolution mechanism.

27. The method of claim 26, wherein an operator of the pet care service marketplace acts as a moderator to facilitate resolution of disputes among members, and the act of providing dispute resolution includes at least one of auditing potin accounts, auditing transactions, suspending members, expelling members, add points, and deduct points.

28. A computer-readable medium having computer-readable signals stored thereon that define instructions that, as a result of being executed by a computer, instruct the computer to perform a method for matching pet care service providers with pet owners, the method comprising acts of:
creating a member profile of at least one member in response to a request to join the pet care service marketplace;
determining a pre-determined point value of a pet care service;
assigning the pre-determined point value to the pet care service;
matching a service desired by the at least one member with a service willing to be performed by at least one other member;
debiting a number of points of the at least one member after completion of the pet care service by the at least one other member; and
crediting a number of points of the at least one other member after completion of the pet care service by the at least one other member.

29. The computer-readable medium of claim 29, wherein the method further comprises an act of maintaining an equilibrium of points within the pet care service marketplace.
